(19) United States
(12) Patent Application Publication
(10) Pub. No.: US 2008/0243521 A9
(43) Pub. Date: Oct. 2, 2008

(54) SIMULATING USER IMMERSION IN DATA REPRESENTATIONS

(75) Inventors: Howard S.L. Coale, Philadelphia, PA (US); Jonathan Sawyer, Fort Washington, PA (US)

Correspondence Address: FISH & RICHARDSON P.C., P.O. BOX 1022, MINNEAPOLIS, MN, 55440-1022, US

(73) Assignee: TACITUS, LLC, Philadelphia, PA (US)

(21) Appl. No.: 11/552,050

(22) Filed: Oct. 23, 2006

Related U.S. Application Data
(60) Provisional application No. 60/729,590, filed on Oct. 24, 2005.

(51) Int. Cl. G06Q 99/00

(52) U.S. Cl. 705/1

(57) ABSTRACT

The disclosure provides various systems, methods, and software supporting user immersion in data representations. Software for virtual immersion in large datasets identifies a dataset at least partially based on abstract information, with the dataset comprising a plurality of data elements including at least a first data element of a first type and a second data element of a second type. The software then generates a three-dimensional virtual environment based on the identified dataset. This virtual environment may include a first graphical element based on the first data element and a second graphical element based on the second data element. Each graphical element is associated with one or more simulated expression elements based, at least in part, on the state of the dataset. The software then presents at least a portion of the virtual environment to a user such that the user may interact with the dataset within the virtual environment.

### RELATED APPLICATION

This application claims the priority under 35 U.S.C. § 119 of Provisional Application Ser. No. 60/729,590, filed Oct. 24,2005 and entitled DATA GAMING SYSTEM AND METHOD.

### TECHNICAL FIELD

The disclosure relates to data processing and, more particularly, to data immersion systems, methods, and software that simulate, provide, or otherwise facilitate any suitable user immersion within a three-dimensional (3D) or four-dimensional (4D) representation of abstract data.

### BACKGROUND

Available data has grown over the last few years, and may continue to grow exponentially, making vast leaps in terms of the amounts, types, and complexity of available financial, business, population, biological, and other data. For example, globally located genomic and proteomic databases (as well other biological, genetic and biomedical databases) have grown at what could be considered an astonishing rate. In one instance, GenBack, which is a database managed by the National Center for Biotechnology Information (NCBI) and the National Institutes of Health (NIH), stores data on known public DNA and protein sequences and also stores vast amounts of bibliographic and biological annotations for these same sequences. In 1997, it is believed that GenBank stored data on approximately 2 billion nucleotides from roughly 2 million sequences. In April 2003, it is believed to have increased to 31 billion nucleotides from 24 million sequences. Indeed, over the period of 1982 and 2003, the number of bases in GenBank doubled approximately every 14 months and it is possible that the growth rate of Genbank's data even increased beyond that. In another example, available financial data on companies, currencies, markets, industries, economic trends, and so forth are vastly increasing, some of it likely due to increasing reporting, data storage, and data processing capabilities. This data may be collected through government and regulatory reports, shareholder reports, confidential information from business relationships, Dun & Bradstreet, or other sources of commercial information. In yet another example, U.S. Census data collected by the U.S. government, as well as world population data collected by the United Nations, are often used by a large variety of government agencies and hundreds of social-service and non-profit organizations, as well as many U.S. companies, in order to make strategic and tactical decisions. These populations data sets are commonly complex, interwoven, dense, and difficult to parse, refine, or navigate due to many hundreds of categories and sub-categories of demographic, economic, and geographic information. Such information in turn may be connected to a multitude of other related data set categories and sub-categories, as well as tangential information (business data, climate data, agricultural data, etc.) that might be overlaid on these complex data sets.

### SUMMARY

The disclosure provides various embodiments of systems, methods, and software supporting user immersion in data representation. For example, software for virtual immersion in large datasets may identify a dataset at least partially based on abstract information, with the dataset comprising a plurality of data elements including at least a first data element of a first type and a second data element of a second type. The software may then generate a three-dimensional virtual environment based on the identified dataset. This virtual environment may include a first graphical element based on the first data element and a second graphical element based on the second data element. Each graphical element is associated with one or more simulated expression elements based, at least in part, on the state of the dataset. The software is then operable to present at least a portion of the virtual environment to a user such that the user may interact with the dataset within the virtual environment.

The foregoing example software—as well as other disclosed processes—may also be computer implementable methods. Moreover, some or all of these aspects may be further included in respective systems or other devices for supporting use immersion in data representations, as well as in other enterprise or data mining software. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 is a schematic diagram showing an example system that provides or facilitates any suitable user with immersion within a three-dimensional (3D) or four-dimensional (4D) representation of data in accordance with certain embodiments of this disclosure;

FIG. 2 is a more detailed example of a data immersion application in accordance with certain embodiments of FIG. 1;

FIG. 3 illustrates example data expressions used to visually or otherwise express data in accordance with certain embodiments of FIG. 1;

FIG. 4 is a flow chart showing an example computer implementable process for creating a data immersion environment in accordance with certain embodiments of this disclosure;

FIG. 5 is a flow chart showing an example computer implementable process for processing a particular instance of the data immersion environment in accordance with certain embodiments of this disclosure; and

FIG. 6A-C are example graphical user interfaces supporting user immersion in large data sets in accordance with certain embodiments of this disclosure.

### DETAILED DESCRIPTION

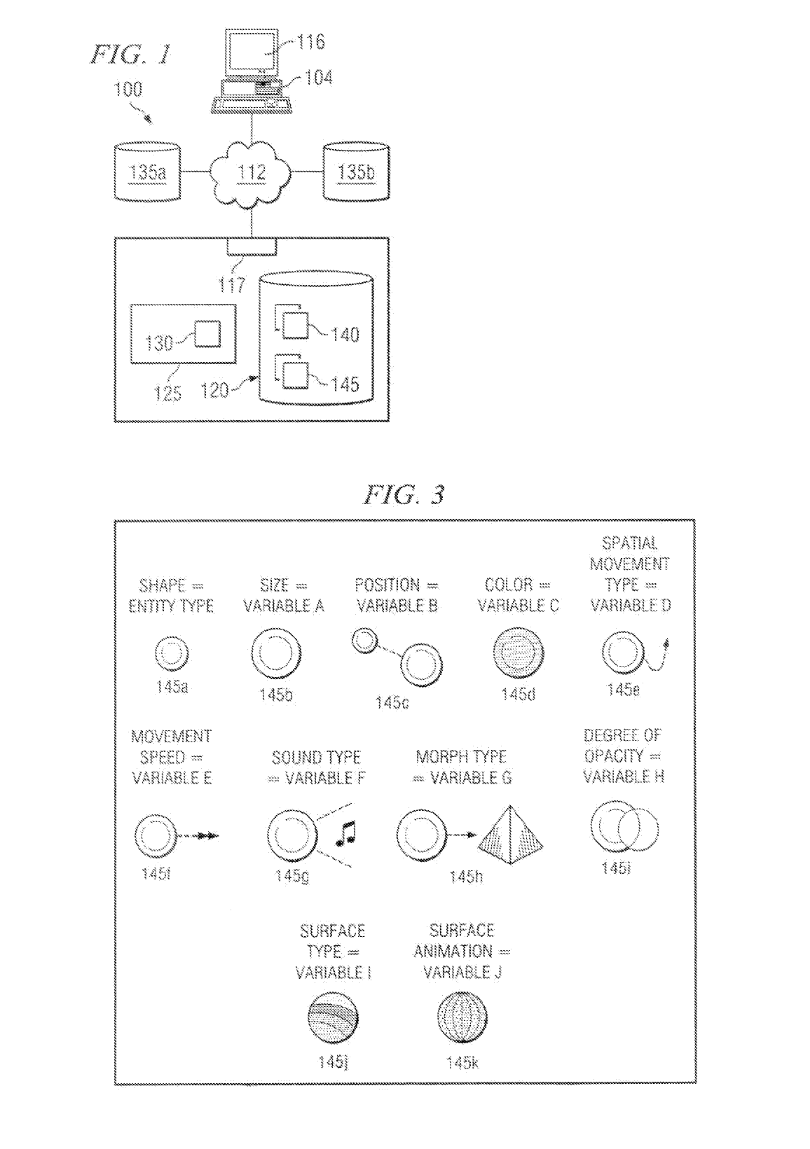

FIG. 1 is a schematic diagram showing an example system 100 for traversing, viewing, and processing, as well as managing, often large and complex datasets that store or otherwise represent abstract information. Generally, the data immersion system 100 provides any suitable user—including multiple logically remote or unrelated users—with comprehensible and useful immersion within a three-dimensional (3D) or four-dimensional (4D) representation of (potentially vast or massive amounts of) data. This data may be in any suitable format and may store any type of abstract information including, for example, financial data, business data, medical data, insurance data, census or population data, biological or genomic data, astrophysics or astronomical data, and other types of abstract data not typically based on physical or morphological dimensions or that has no prior physical, representational form. Put another way, while the data may relate to quite specific or detailed information (such as numbers, genetic history or past, relationships, interactions, etc.), the information can be partially, substantially, or fully unrelated to physical properties that may be somewhat easily represented (such as “drawing” a chair based on its dimensions.) System 100 then simulates this data in a virtual environment using physical expressions on physical structures such that the user can travel through or otherwise interact with this “abstract” data. The data can also change in real-time due to influences outside system 100, such as by data input users other than the user of the data, external applications, or data loads. Accordingly, the data and the simulation can dynamically change in response to external influences. In short, data may be represented to the user, perhaps himself represented as a simulated physical person (or avatar), with certain traits and/or behavior.

The simulated or virtual environment provided by the disclosed systems and methods is often one through which the user self-navigates. In this context, self-navigation generally means that the user may make choices and may have one or more pathways through the data. More particularly, the user may typically move, navigate, interact, effect change, manipulate, or change his own state within the simulated physical environment either as himself or by way of an “avatar” that represents him. Each user may assign or modify attributes to the simulated physical expressions of the data such as size, color, personality, behavior, relationships, and so forth. The simulation, or experience may further include a time element such that the simulation changes states over time and may have different states at any different time. The virtual environment may also allow the users to interact with the data to manipulate the data (adding data, removing data, creating new data from existing data, etc.). Indeed, the data immersion system may allow for team collaboration involving role playing or for multiple users from various entities to view the same data and dynamically witness changes on the data as other users interact with the same data. In other words, the interface may allow remote collaboration and/or co-experiencing of the dynamically simulated data. Accordingly, each user may see—perhaps in real-time—the other users and/or see changes in the environment due to actions of other users.

More specifically system 100 may offer “expression variables” is showing multiple data elements, data qualities, and data network relationships. Put another way, by using a more “immersive” approach in dynamic, interactive 3D in which causation and time are represented, the amount of data types, qualities, and relationships that can be expressed at any given moment may increase significantly. This artificial environment offered by system 100 may provide more than static 2D expressions including, for example, three-dimensional surface animation, three-dimensional surface texture and type, sound, morph type (both 2D and 3D) over time, spatial movement type (movement across X, Y, and Z axes), lighting (by way of game platform atmospherics), spatial and volumetric sizing, as well as relationships across virtual or other logical distance, elasticity, and degree of response (when user interacts with object) including sound response, physicas response (how the object reacts to physics), motion and speed response, and any other appropriate audiovisual, virtual (such as a screen shake), or physical response (such as vibration of a mouse, “joystick,” or other device).

For example, in drug development, biotechnology, oncology, biomedical, and other similar research, deeper and more facile understanding of cell interaction pathways —generally, the gene-regulated communication lines between proteins and other inter-cellular molecules —are utilized for creating genetically-targeted therapies, as well as creating a foundation for the future of cell research. When these cell interaction pathways malfunction, mutations often take place. These mutations can lead to cancer or other serious medical conditions. Accordingly, system 100 may be or include a digitally represented, computer expressed model in which the user experiences complex cell interaction pathway data in an interactive graphic format, much like a three-dimensional game space or digitally-represented artificial environment. Within this artificial environment, the user may—for example—navigate through macro and micro views of cell interaction pathways and their components, view proteins and their relationships to function, manipulate “on” and “off” states of genes in order to visualize their effects on interactions and protein-states, and manipulate protein function, etc., in order to view and analyze the cell interactions as a functioning and interdependent whole. In this example, system 100 may provide better, more interactive, and more intuitive tools for navigating and visualizing the complex data sets that describe and define cell interaction pathways and their relationship to both function and malfunction within cells. In another biological example, system 100 may facilitate phylogeny, which is the genealogical map for lineages of life on earth, by providing an overall framework for information retrieval and biological prediction. In this case, system 100 can help model the extreme complexity of the roughly 1.7 million species on Earth, and their phylogenetic relationships, as a simulated physical environment that would allow a user or multiple users to self-navigate throughout a simulated physical structure representing the entire tree.

In another implementation, government agencies, regional, national, and multinational corporations, and non-profit social and economic organizations may use system 100 to more easily view and process population data. In this way, these organizations, companies, and government agencies may view population data not only from a macro view (entire country, state, region, or county), but also from an immersive, “personal” view; i.e, specific social groups and types of individuals, neighborhood composition, living circumstances, proximity to resources, availability of education and distance to healthcare, and so forth, that can benefit from greater levels of detail and precision. In other words, system 100 may offer a combination of macro, micro, immersive, and “personal” views of population and census data, thereby potentially giving users the ability to zoom in to view simulated circumstances of neighborhoods, for instance, within a specific town (in three-dimensional, fully-interactive shapes, colors, human icon figures, potentially integrated for instance with satellite mapping data, vegetation and farming data, etc.), or outward to city, state, regional, country or continental views within a navigable, immersive three or four-dimensional virtual environment.

Turning to the illustrated components, data immersion server 102 may be any business, entity, or computer that helps collect and manage (potentially large amounts of) data for use by one or more users. For example, illustrated data immersion server 102 comprise en electronic computing device operable to receive, transmit, process, and/or store at least some data associated with system 100. Each computer is generally intended to encompass any suitable processing device. System 100 can be implemented using computers other than servers, as well as a server pool. Indeed, date immersion server 102 purpose personal computer (PC), Macintosh, workstations. Unix-based computer, or any other suitable device. In other words, the present disclosure contemplates computers other than general purpose computers as well as computers without conventional operating systems. Data immersion server 102 may be adapted to execute any operating system including Linux, UNIX, Window Server, or any other suitable operating system. In certain implementations, data immersion server 102 may also include or be communicably coupled with a web server and/or a mail server.

Data immersion server 102 includes (or is communicably coupled with) memory 120. Memory 120 may include any memory or database module and may take the form of volatile or non-volatile memory including, without limitation, magnetic media, optical media, random access memory (RAM), read-only memory (ROM), removable media, or it may also be communicable coupled with any intra-enterprise, inter-enterprise, regional, nationwide, or global electronic storage facility 135, data processing center 135, or archive 135 that allows for one or a plurality of clients 104 to dynamically store and retrieve data. Moreover, while generally described as local, memory 120 may be physically or logically located at any appropriate location such that it may be generally managed, controlled, or otherwise associated with server 102 and store dataset 140 and data expressions 145.

Dataset 140 includes any parameters, pointers, variables, algorithms, instructions, rules, files, links, or other data. In certain implementations, data elements of data set 140 (or pointers thereto) may be stored in one or more tables in a relational database described in terms of SQL statements or scripts. In other complementary or alternative implementations, data elements may be formatted, stored, or defined as various data structures in text files, extensible Markup Language (XML) documents, Virtual Storage Access Methods (VSAM) files, flat files, retrieve files, comma-seperated-value (CSV) files, internal variables, or one or more libraries. For example, a particular dataset 140 record may merely be a pointer to a third party record stored remotely. In another example, the dataset 140 may be a local (partial or full) instance of dataset 140 distributed across one or more remote repositories 135. In this example, the repositories 135 (such as 135a and 135b) may represent a distributed database, such as GenBank, or may represent sources of different datasets 140. Also, these distributed datasets 140 may comprise related or unrelated data as appropriate. In short, dataset 140 may comprise one table or file or a plurality of tables or files stored on one computer or across a plurality of computers in any appropriate format. Indeed, some or all datasets 140 may be local or remote without departing from the scope of this disclosure and may store any type of appropriate data. For example, the datasets 140 may comprise business, financial, economic, population, astrophysical, geological, biological, and/or any other data and information.

Data expressions 145 are any pre-generated graphical elements used to visually or otherwise express data to users including graphical, behavioral, auditory, interactive, temporal and spatial elements that represent data in an artificial 3D environment. More specifically, these expressive elements help represent data in three-dimensional, allowing the display and manipulation of many more data sets and types, as well as many more facets, optional hidden areas, and so on to help display these characteristics. For example, as shown in FIG. 3, these graphical elements may associated with expression attributes that are assigned to various graphical elements within the immersion environment based on the state of the data. In this example, the illustrated attributes may include a graphical element type (such as a sphere, pyramid, block, pathway, avatar, logos, etc.), element size element position, element color, spatial movement type (such as bouncing, spinning, orbiting, etc.), movement speed, sound type, morph type (such as the illustrated sphere morphing to the pyramid), opacity, surface type, and surface animation.

Data immersion server 102 also includes processor 125. Processor 125 executes instructions and manipulates data to perform the operations of data immersion server 102 such as, for example, a central processing unit (CPU), a blade, an application specific integrating circuit (ASIC), or a field-programmable gate array (FLGA). Although FIG. 1 illustrates a single processor 125 in data immersion server 102, multiple processors 125 may be used according to particular needs and reference to processor 125 is meant to include multiple processors 125 where applicable. In the illustrated implementation, processor 125 executes data immersion application 130.

At a high level, the data immersion application 130 is operable to immerse one or more users within a large dataset 140 and allow various interactions via an interface. More specifically, data immersion application 130 is any application, program, module, process, or other software that can help provide a digitally-represented 3D (or 4D) space in which a user or users can navigate in, manipulate, and interact with objects, other users represented by avatars, or with any other digitally represented entity, as well as move within the data by way of a first-person or third-person view and/or avatar and effect change upon objects, entities, states and/or behaviors. For example, data immersion application 130 may implement some or all of the following functionality; an artificial 3D (or 4D with time-based behavior) environment in which users can perhaps: i) interact and effect causational change and observe the results of their actions/interactions upon the artificial environment, ii) navigate through the artificial environment at will; iii) zoom to various levels of scale within the data as represented by the artificial environment; iv) interact and/or communicate with multiple other users within the artificial environment; and v) enter other artificial 3D environments or levels as in a video game. Of course, certain implementations may include other functionality as well without departing from the scope of this disclosure. For example, certain applications 130 may include a security module that implements various security profiles or settings that help ensure that only authorized users view, update, or otherwise interact with the particular dataset 140. In another example, certain applications 130 may include an audit module that tracts the various changes to help comply with various business, regulatory, or statutory requirements. In yet another example, application 130 may include various interfaces to external application (such as email, business applications, and so on) that allow the user to view, communicate, or report on various data—and perhaps the changes made thereto—within the immersion session.

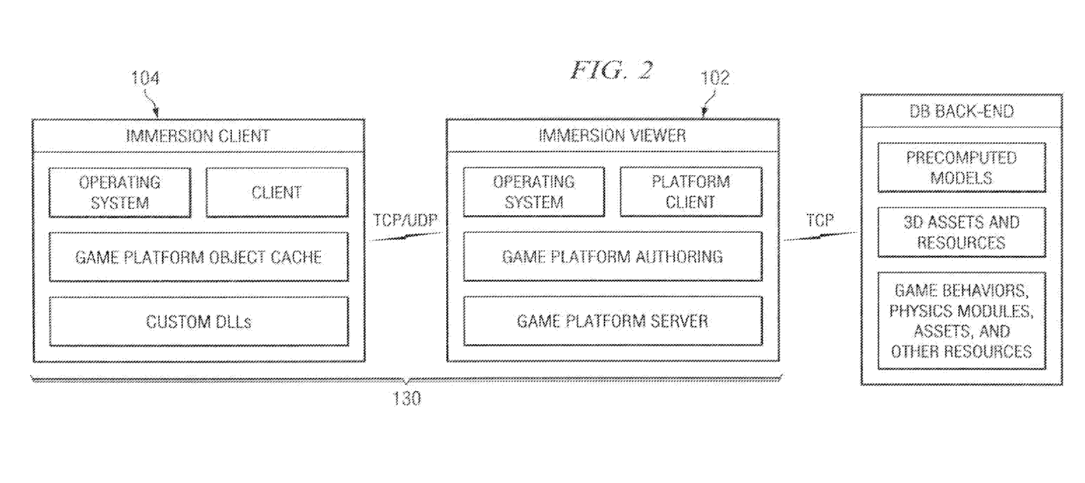

Regardless of the particular implementation, “software” may include software. firmware, wired or programmed hardware, or any combination thereof as appropriate. Indeed, data immersion application 130 may be written or described in any appropriate computer language—or combination thereof—including C, C++, Java, Visual Basic, PHP (recursive PHP: Hyertext Processor), assembler, Perl, any suitable version of 4GL, as well as others. For example, returning to the above described composite application, the composite application portions may be implemented as Enterprise Java Beans (EJBs) or the design-time components may have the ability to generate ren-time implementation into different platforms, such as J2EE (Java 2 Platform, Enterprise Edition), or Microsoft's.NET. It will be understood that data immersion application 130 may include numerous other sub-modules (as sown in example FIG. 2) or may instead be a single multi-tasked module that implements the various features and functionality through various objects, methods, or other processes. Further, while illustrated as internal to data immersion server 102, one or more processes associated with data immersion application 130 may be stored, referenced, or executed remotely. For example, some of the processes or modules may reside—or distributed processing take place—on client 104 or repository 135 as appropriate. Moreover, data immersion application 130 may be a child, sub-module, or front-end of another database or data mining module or application (not illustrated), for example, without departing from the scope of this disclosure.

Data immersion server 102 may also include interface 117 for communicating with other computer systems, such as clients 104 or repository 135, over network 112 in a client-server or other distributed environment. In certain implementation, data immersion server 102 receives data from internal or external senders through interface 117 for storage in local memory 120 and/or processing by processor 125. Generally, interface 117 comprises logic encoded in software and/or hardware in suitable combination and operable to communicate with network 112. More specifically, interface 117 may comprise software supporting one or more communications protocols associated with communications network 112 or hardware operable to communicate physical signals.

Network 112 facilitates wireless or wireline communication between data immersion server 102 and any other local or remote computer, such as clients 104. Network 112 may be all or a portion of an enterprise or secured network. In another example, network 112 may be a VPN merely between data immersion server 102 and client 104 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least a portion of network 112 may facilitate communications between data immersion server 102 and at least one client 104. For example, data immersion server 102 may be communicably coupled to a repository through one sub-net while communicably coupled to a particular client 104 through another. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan are networks (MANs), wide area networks (WANs), all or a portion of the global computer network known as the Internet, and/or any other communication system or systems at one or more locations. In certain implementations, network 112 may be a secure network associated with an enterprise and certain local or distributed clients 104.

Client 104 is any computing device operable to connect or communicate with data immersion server 102 or network 112 using any communication link. At a high level, each client 104 includes or executes at least GUI 116 and comprises an electronic computing device operable to receive, transmit, process and store any appropriate data associated with system 100. It will be understood that there may be any number of clients 104 communicably coupled to data immersion server 102. Further, “client 104” and “user” may be used interchangeably as appropriate without departing from the scope of this disclosure. Moreover, for ease of illustration, each client 104 is described in terms of being used by one user. But this disclosure contemplates that many users may use one computer or display or that one user may use multiple computers or displays.

As used in this disclosure, client 104 is any person, department, organization, small business, enterprise, or any other entity that may use or request others to use system 100, namely, data immersion application 130. Client 104 is intended to encompass a personal computer, touch screen terminal, workstation, network computer, kiosk, wireless data port, smart phone, personal data assistant (PDA), one or more processors within these or other devices, or any other suitable processing device used by a user to interact within the virtual environment. For example, client 104 may be a PDA operable to wirelessly connect with external or unsecured network. In another example, client 104 may comprise a laptop that includes an input device, such as a keypad, touch screen, mouse, or other device that can accept information, and an output device that conveys information associated with the operation of data immersion server 102 or clients 104, including digital data, visual information, or GUI 116. Both the input device and output device may include fixed or removable storage media such as a magnetic computer disk, CD-ROM, or other suitable media to both receive input from and provide output to users of clients 104 through the display, namely the client portion of GUI or application interface 116.

GUI 116 comprises a graphical user interface operable to allow the user of client 104 to interface with or be virtually immersed within at least a portion of system 100 for any suitable purpose, such as viewing application, transaction, or other data. Generally, GUI 116 provides the particular user with an efficient and user-friendly presentation of data provided by or communicated within system 100. GUI 116 may present that virtual environment with a plurality of graphical elements and immersive expressions. For example, GUI 116 is operable to display certain data elements of dataset 140 is a user-friendly form based on the user context and displayed data. In fact, GUI 116 often allows for a mixture of simulated physical environments with, for instance, tabular navigation, animated behavior, or sound events. GUI 116 is normally configurable, supporting a combination of table or graphs (bar, line, pie, status dials, etc.), and is able to build 3D representation of such table and graphs, where such representations (as well the displayed application or transaction data) may be relocated, resized, updated, deleted, and such. It should be understood that the term graphical user interface may be used in the singular or in the plural to describe one or more graphical user interfaces and each of the displays of a particular graphical user interface. Indeed, reference to GUI 116 may indicate a reference to the front-end or a component of data immersion application 130, as well as the particular interface accessible via client 104, as appropriate, without departing from the scope of this disclosure. Therefore, GUI 116 contemplates any graphical user interface, such as a generic web browser or touch screen, that processes information in system 100 and efficiently presents the results to the user. Data immersion server 102 can accept data from client 104 via the web browser (e.g. Microsoft Internet Explorer or Netscape Navigator) and return the appropriate HTML or XML responses to the browser using network 112.

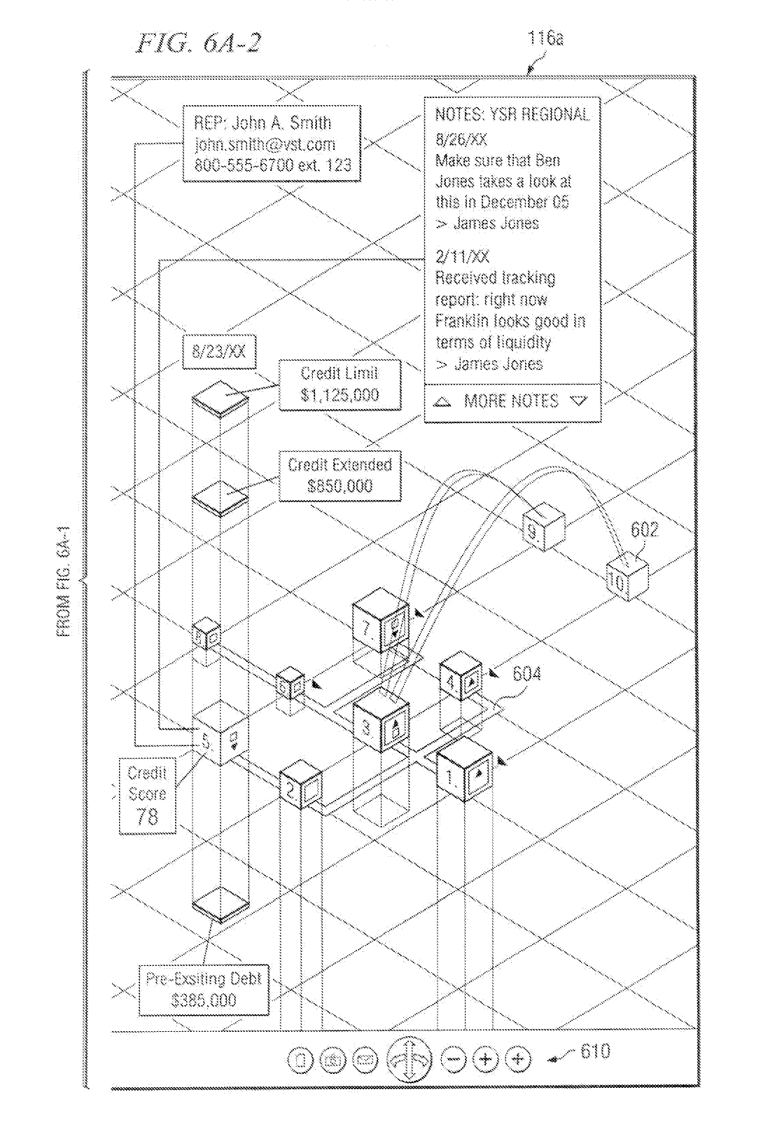

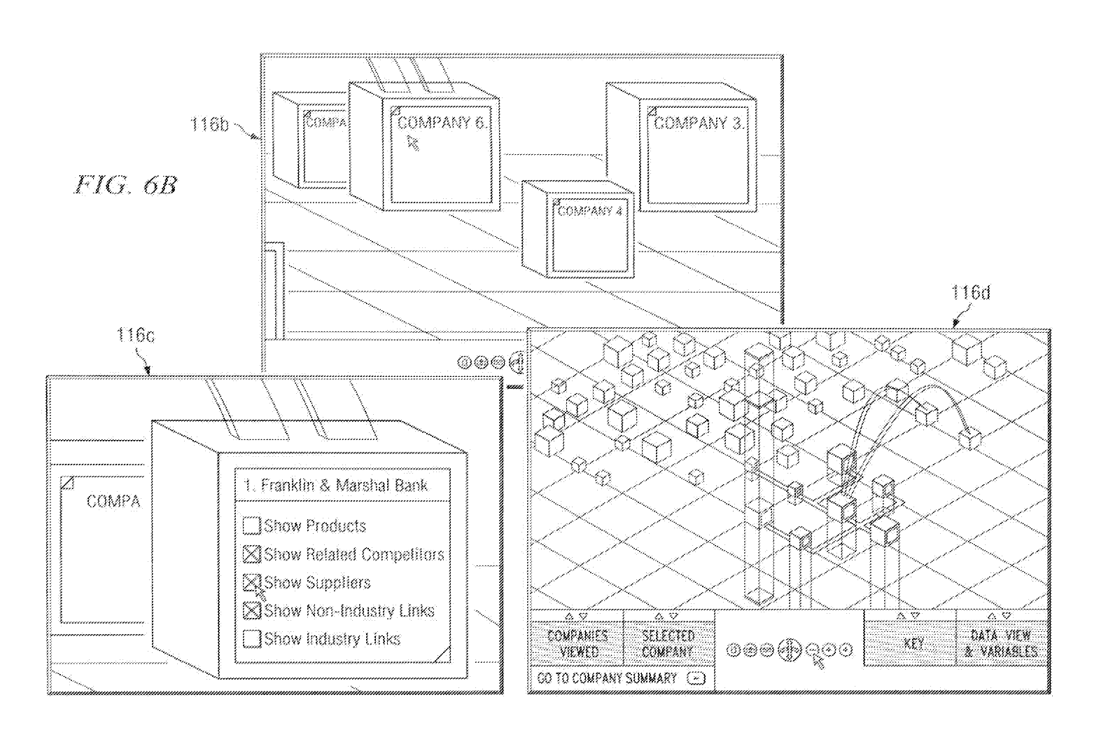

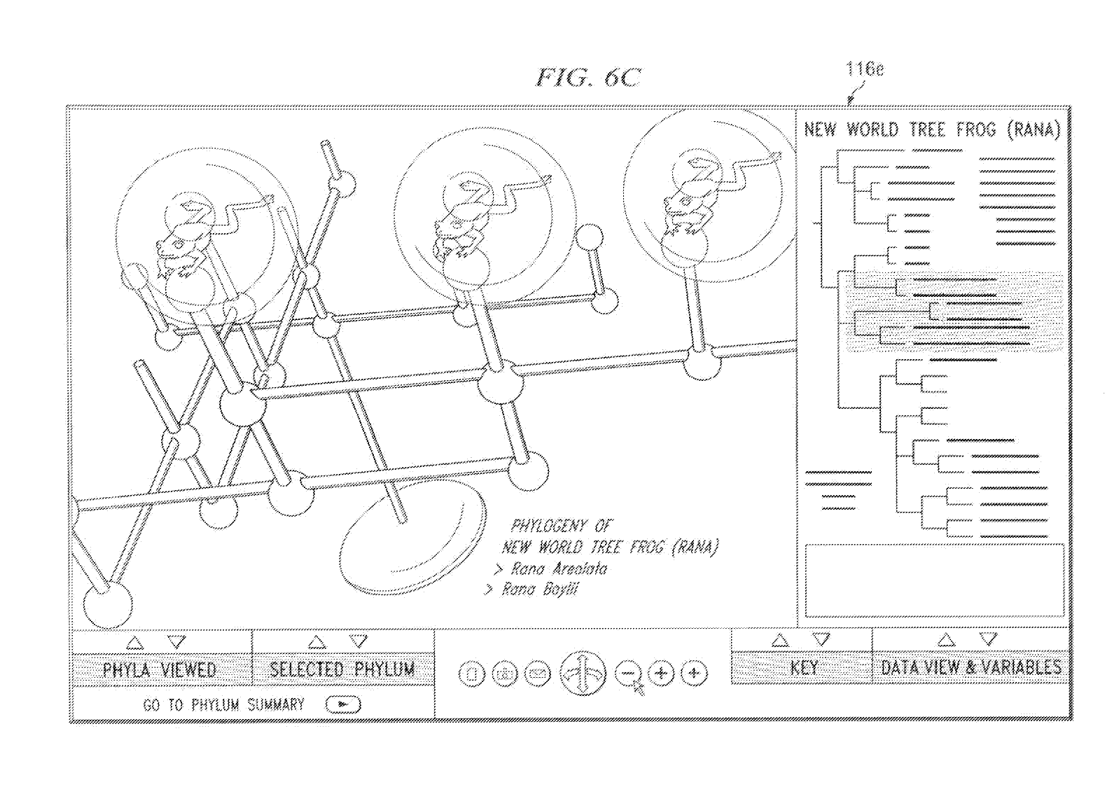

In one example aspect of operation, FIGS. 6A-C show example portions of a virtual environment using various datasets 140. More specifically, FIG. 6A is an example of a graphical user interface 116a that provides immersion visualization and interaction with complex financial data that relates to the relationships between, and the financial health of, example companies. In this example, GUI 116a presents company graphical elements 602, pathway elements 604, various control pads 606, a search field 608, and interface 610. Illustrated company element 602 represents a company, while its size represents comparative revenue, labor force size, or other variables established by the user or application 130 (either automatically, dynamically, or using a user profile). User data on companies may be overlaid on database-provided data, while purple arcs show related competitors and blue and red transparent (upward and downward) columns show credit extended existing debt on a company that is currently one of the user's client. Also, each side of the cube can offer access—perhaps upon zooming in and interacting—with data that is either shown or hidden until the user interacts. In this example, red squares may represent a downward trend in score, while green represents an upward trend. As shown in FIG. 6B (GUIs 116b-d), detailed data about each company can often be accessed by self-navigating around the boxes. Pathways 504 represent subsidiary-to-parent relationships. In this illustration, the user has swiveled the entire 3D plane around so that the parent company is on the right, with its related subsidiaries branching to the left. Search field 608 provides the user with the ability to quickly and easily search data, as well as view the results in an intuitive fashion. In one example, GUI 116a may provide a results pop-up window. When the user selects a particular result, interface 116a may automatically zoom in on the appropriate element that contains, represents, or references the desired result. More specifically, if the user searches for a particular company, then GUI 116a may display the company and direct subsidiaries, potentially represented as cubes with overlays in three-dimensional space. This search may also automatically link or synchronize with other datasets 140 or repositories 135 as appropriate. Illustrated interface 610 allows intuitive navigation, immersion, travel-through movement, and manipulation of the simulated or virtual environment. For example, interface 610 includes swivel controls, as well as any number pop-up or intelligent control panels 606. These control panels 606 typically allow the user to manage the presentation of the data, as well as quickly view data summary or metadata. Of course, as mentioned above, data immersion application 130 may utilize or present any suitable data, such as biological data, as shown example GUI 116e in FIG. 6C. In this additional example, various elements represent phylogentic trees three-dimensionally, allowing for navigation of extremely complex phyogenics and genetic relationships, as well as allowing researchers and educators to zoom in to more exacting genetic detail.

Turning to FIG. 2, a more distributed implementation of data immersion application 130 is illustrated. In this example, application 130 is distributed across a client portion on client 104 and server portion on server 102, communicably coupled using any appropriate communication protocol such as Transmission Control Protocol (TCP) or User Datagram Protocol (UDP). The client portion includes the platform client agent, an object cache, and one or more DLLs. The object cache may process configurations and management from the server 102, while the DLLs may include customized DLLs that allow for or facilitate pre-computation or otherwise extend the platform. The server 102 includes a server module that may instantiate one or more client or session objects that are operable to communicate with a plurality of clients 104. The server portion further includes an authoring module that helps manage licensing, publishing and passive resource management. Illustrated server portion further implements a client or interface portion that communicates with a database backend or the one or more remote repositories 135. The example Db backend may store pre-computed models, 3D assets and resources, as well as game behaviors, physics modules, and so forth. This backend may be any suitable database, data repository, or protocol including Open Database Connectivity (ODBC), SQL, J2EE, XML/SOAP (Simple Object Access Protocol), .NET, etc.

It will be understood that while this example describes one confiruration of data immersion application 130, it may instead be a standalone or (relatively) simple software program integrated with other distributed module or functionality. Moreover, data immersion application 130 may locally include or be remotely linked with some or all of the illustrated components, as well as other not illustrated.

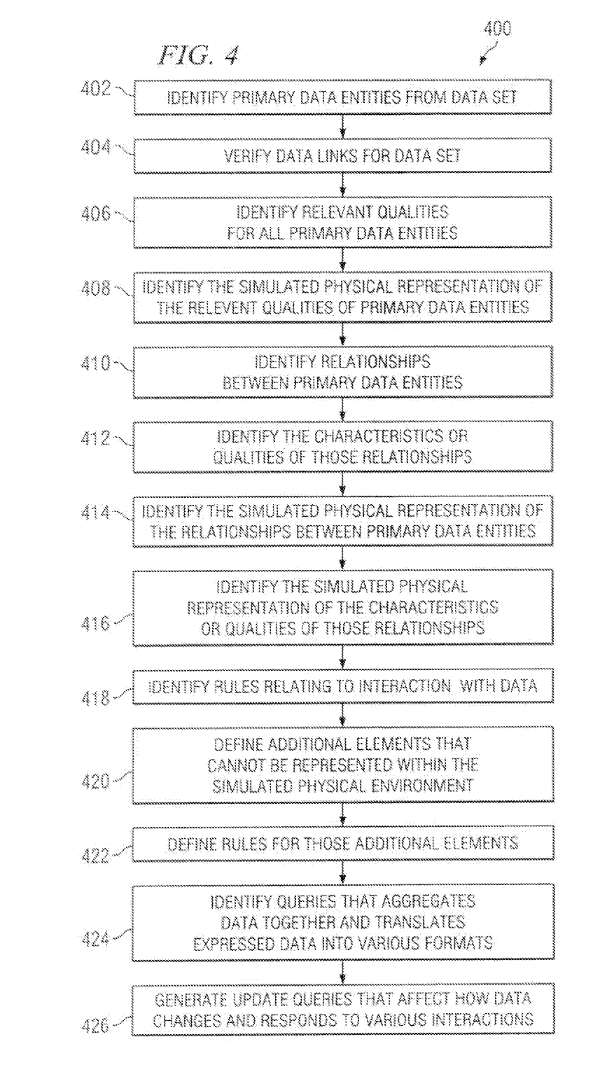

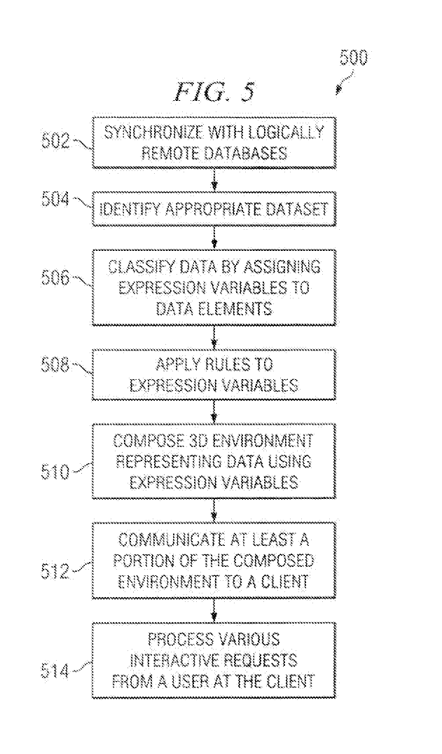

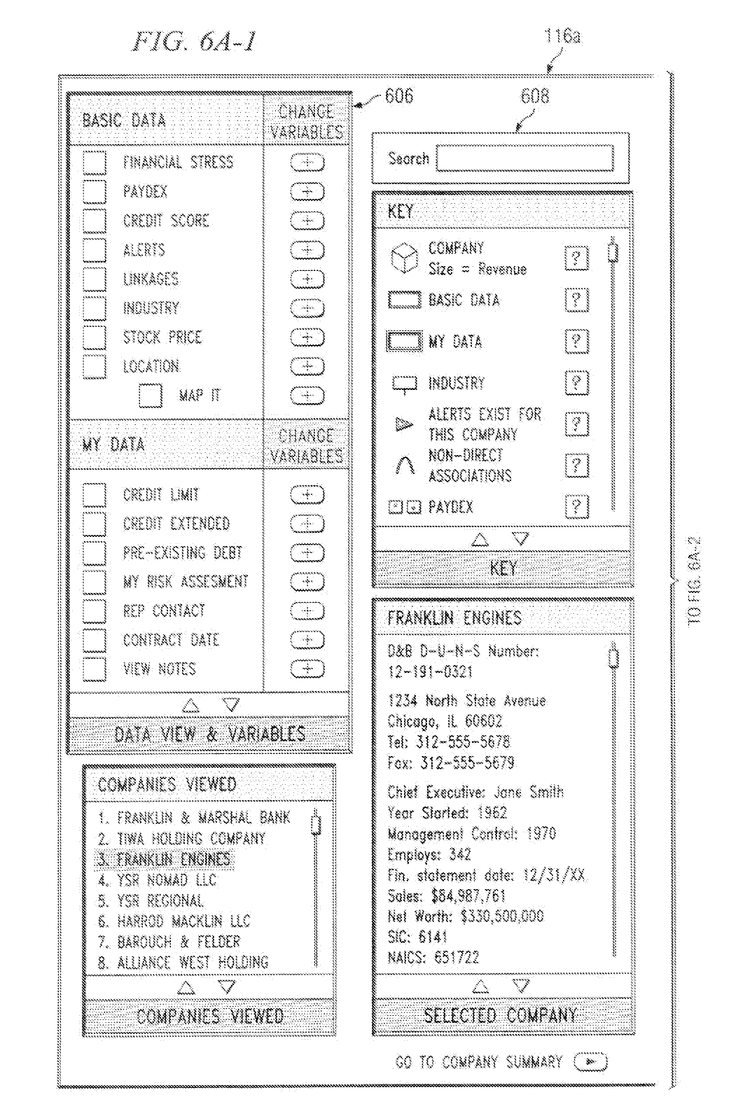

Regardless of the particular hardware or software architecture used, data immersion application 130 (and the various example components, whether internal, linked, or distributed) is generally capable of processing and implementing the various immersion processes and techniques. Some of these processes are illustrated in certain flowsharts described below. For example, FIGS. 4 and 5 are flowcharts showing methods 400 and 500, respectively. These techniques may be performed, for example, by any suitable system and, for clarity of presentation, the following description uses system 100 (and data immersion application 130) as the basis of examples for describing these processes. But system 100 contemplates using any appropriate combination and arrangement of software elements implementing some or all of the described functionality.

FIG. 4 is a flow chart showing an example of method 400 for developing, initializing, or otherwise creating a data immersion or other virtual environment in accordance with certain embodiments of this disclosure. Generally, method 400 describes one technique for defining or identifying various aspects that can be used to implement the virtual environment with various levels of user input; in other words, some or all of these creation steps may occur with or without user input or direction as appropriate. Data immersion application 130 executes this example method beginning at step 402, with identifying primary data entities or elements for a particular dataset 140 such as data objects for companies, species, and so forth. For example, application 130 may parse dataset 140 into primary and supporting entities. In another example, application 130 may load a definition file that identifies the particular data schema (including the primary keys). These primary entities may be partially or fully associated with local DB or various repositories 135. At this point, application 130 may verify the date links (such as ODBC or JDBC) or otherwise help ensure that the data entity might be accessible upon demand.

Next, at step 406, application 130 defines relevant quantities for the identified primary data entities. The relevant qualities may be a default for target users. For example, if the target users might be business users immersed within financial data, then one relevant quality may be revenue numbers, credit score, accounts receivable, and others determined by targeted client's settings or pre-generated to facilitate subsequent dynamic determination. Application 130 then, at step 408, identifies the simulated virtual representations of the earlier identified relevant qualities. Part of this identification may include whether the quality is a required displayed quality or other metadata associated with the particular quality. Moreover, this definition may determine that this quality may be associated with an event, a shape, a color, a behavior, a sound, a surface or other tactile attribute, or many other effects or expressions. Relationships between various primary data entities in dataset 140 may then be defined or otherwise identified at step 410. These relationships may include subsidiary, vendor-customer, parntership, or other financial or commercial relationships. With respect to genetics, the relationships may include phyla, chromosomal, or other categorical definitions. Each of the relationships or relationship types may then de defined by various characteristics or qualities, such as identifying the scope of or a type of this particular relationship, at set 412. Next, at step 414, application 130 identifies the simulated representation of the defined or identified relationships. Such physical representations may include pathway shapes, colors, sounds, or visualization effects (such as shading, rotating, blinking, etc.) In some cases, the simulated representation of the various characteristics or qualities may also be identified, defaulted, or otherwise defined at step 416. For example, with respect to the phylogenetic data, the number of chromosomes may be represented by the diameter of a sphere displayed beneath a particular sub-species. With respect to a commercial example, the commercial relationship may be blinking if a known termination date is approaching.

Once the various graphical elements and expressions are identified, then application 130 loads or defines rules pertaining to the interaction with dataset 140 at step 418. For example, if the user performs a particular action, then the virtual environment may reflect a particular graphical element. In response to a second action, the virtual environment may present a graphical change to the displayed items. In certain situations, there may be data or events that are not to be represented as one or more graphical elements for any number of reasons (as shown at step 420), such as user preference, a particular obstacle, and so forth. When this occurs, application 130 may load, invoke, or define rules for those additional elements at step 422. For example, whenever that data or event is associated with the particular portion of the virtual environment displayed to the user, then application 130 may automatically perform certain steps, including notifying the user via a pop-up window, playing a sound or video clip, or communicating a message to an external application (not shown). Next, at step 424, application 130 may identify or define queries that aggregate or filter appropriate data. In some instances, these or other queries may also be used to automatically format the data for use by one or more GUIs 116 or applications. In other words, application 130 may generate a query or script that parses the desired data and reformats it into, for example, HTML for use by different browsers or, in another example, a more generic XML for various front-ends of other applications. At step 426, application 130 may also load, identify, or generate update queries that would change (whether add, modify, or delete) the proper data in response to a particular action by the user.

After the dataset 140 has been suitably processed or identified (perhaps as shown in example method 400), the application 130 may generate the virtual environment using techniques similar to that shown in FIG. 5, which illustrate example method 500. Illustrated method 500 begins at step 502, where (when appropriate, such as upon initialization) data immersion server 102 synchronizes with one or more (at least logically) remote databases or repositories 135 for one or more datasets 140. For example, application 130 may determine that a local copy or portion of remote data is outdated or likely to have changed. In this case, application 130 may collect or integrate the delta from repositories 135 using an efficient data synchronization algorithm. In another example, application 130 may determine that portions of the data substantially reside or are available from remote repositories. Moreover, this synchronization may include any other suitable database functionality including rollback or recovery in case of prior errors. Application 130 may then ensure that it has suitable database connectivity to such repositories. This may include helping ensure that the most efficient channel or path (such as with the highest bandwidth) is opened for communications.

Once the various data destination are identified and potentially synchronized, then application 130 may identify the appropriate data within the dataset 140 for the particular user at client 104 at step 504. For example, application 130 may determine that certain data is inappropriate for a user because the data is outdated, the user's role or security settings, or preferences. Conversely, application 130 may determine that more data may be appropriate for this particular user and return to step 502 as needed to load or update this additional data. Next, at step 506, application 130 may classify the data be assigning expression variables or settings to some or all of the data elements of dataset 140. Application 130 then applies rules to these expression variables, which were potentially generated or loaded during the example processing described in FIG. 4, at step 508. Based, at least in part, on the various settings and classifications, application 130 generates the virtual environment data at step 510. This generation may include performing any suitable graphical processing such as texture mapping, rendering, and so forth to often achieve higher quality or better performance. Once generated, at least a portion of this virtual environment is communicated to at least one client 140 at step 512 for use by the particular user at step 514. As described above, this environment—or a portion thereof—may be shared by multiple users in a collaborative environment that reflects the various changes and interactions of these users.

The preceding flowcharts and accompanying descriptions illustrate example methods. But system 100 contemplates using any suitable techniques for performing these and other tasks. For example, application 130 may automatically determine the various data elements, relationships, and rules based on defaults. In another example, application 130 may automatically filter or otherwise secure various data or data types based on security profiles or settings. Accordingly, many of the steps in these flowcharts may take place simultaneously and/or in different orders than as shown. Moreover, the system 100 may use methods with additional steps, fewer steps, and/or different steps, so long as the methods remain appropriate. For example, it will be understood that they client may execute portions of these processes described in the methods in parallel or in sequence.

A number of embodiments have been described. Nevertheless, it will be understood that various modifications may be made without departing from the spirit and scope of the disclosure. For example, while the server, client, and distributed repository are illustrated as separate, they may instead reside within the same environment, system, or network and represent different components of one device. This implementation may represent a research facility or data mining operation that allows logically local users to view data within the initial storage or collection system. Moreover, it is not required that the client and server reside within the same environment, system, or network, as described. Indeed, the particular client and the particular server may be unrelated wither logically or physically (beyond some connection) and reside in different parts of the globe. Accordingly, other embodiment are within the scope of the following claims.

What is claimed is:

1. Software for virtual immersion in large datasets comprising computer readable instructions that are operable when executed to:
identify a dataset at least partially based on abstract information, the dataset comprising a plurality of data elements including at least a first data element of a first type and a second data element of a second type;
generate a three-dimensional virtual environment based on the identified dataset, the virtual environment comprising a first graphical element based on the first data element and a second graphical element based on the second data element, each graphical element associated with one or more simulated expression elements based, at least in part, on the state of the dataset; and
present at least a portion of the virtual environment to a user such that the user may interact with the dataset within the virtual environment.

2. The software of claim 1, the dataset being business data, with the first data element comprising a corporation and the second data element comprising vendors, and the presented portion of the virtual environment graphically displaying the corporation's relationship to at least a portion of its sub-companies, at least a portion of the corporation's branches, at least a portion of the corporation's financial health, at least a portion of the corporation's structure, a Dun & Bradstreet number, and at least a portion of the corporation's history of suits, liens, and judgments against it.

3. The software of claim 1, further operable to present a fourth dimension in the virtual environment based on time.

4. The software of claim 1, wherein the user interacts with the dataset within the virtual environment by assigning one or more attributes to the dataset by changing one or more simulated expression elements.

5. The software of claim 1, the user comprising a first user and the software further operable to:
present at least a second portion of the virtual environment to a second user such that the second user may interact with the dataset within the virtual environment; and
update the virtual environment presented to the second user in real-time using changed simulated expression elements based on the first user's interaction.

6. The software of claim 1, at least one of the simulated expression elements comprising surface animation, surface texture and type, sound, morph type over time, spatial movement type, lighting, spatial and volumetric sizing, relationships across logical distance, elasticity, or degree of response.

7. The software of claim 1, the dataset comprising a massive distributed dataset.

8. The software of claim 7, further operable to:
logically couple with a plurality of data sources to identify the dataset
synchronize a local repository with at least one remote data source from the plurality of data source; and
wherein the generation of the virtual environment uses the local repository.

9. The software of claim 8, the plurality of data sources comprising a first source associated with a first entity and a second source associated with a second entity.

10. The software of claim 1, wherein the user interacts with the dataset within the virtual environment by navigating through the dataset within the virtual environment.

11. The software of claim 1, further operable to generate an avatar of the user within the virtual environment.

12. The software of claim 1, wherein the dataset is complex cell interaction pathway data and wherein the user interacts with the dataset within the virtual environment by performing one or more of the following:
navigating through views of cell interaction pathways and components;
viewing a plurality of proteins and each protein's relationships to function;
manipulating a state of a gene to visualize effects on interactions and protein-states; or
manipulating a protein function.

13. A virtual immersion system comprising one or more processors operable to:
identify a dataset at least partially based on abstract information, the dataset comprising a plurality of data elements including at least a first data element of a first type and a second data element of a second type;
generate a three-dimensional virtual environment based on the identified dataset, the virtual environment comprising a first graphical element based on the first data element and a second graphical element based on the second data element, each graphical element associated with one or more simulated expression elements based, at least in part, on the state of the dataset; and
communicate at least a portion of the virtual environment to a display such that the user may interact with the dataset within the virtual environment.

14. The system of claim 13, the dataset being business data, with the first data element comprising a corporation and the second data element comprising vendors, and the presented portion of the virtual environment graphically displaying the corporation's relationship to at least a portion of its sub-companies, at least a portion of the corporation's branches, at least a portion of the corporation's financial health, at least a portion of the corporation's structure, a Dun & Bradstreet number, and at least a portion of the corporation's history of suits, liens, and judgments against it.

15. The system of claim 13, the one or more processors further operable to present a fourth dimension in the virtual environment based on time.

16. The system of claim 15, wherein the user interacts with the dataset within the virtual environment by assigning one or more attributes to the dataset by changing one or more simulated expression elements.

17. The system of claim 16, the user comprising a first user and the one or more processors further operable to:
communicate at least a second portion of the virtual environment to a second display such that a second user may interact with the dataset within the virtual environment; and
update the virtual environment presented to the second user in real-time using changed simulated expression elements based on the first user's interaction.

18. The system of claim 15, at least one of the simulated expression elements comprising surface animation, surface texture and type, sound, morph type over time, spatial movement type, lighting, spatial and volumetric sizing, relationships across logical distance, elasticity, or degree of response.

19. The system of claim 13, the dataset comprising a massive distributed dataset.

20. The system of claim 19, logically coupled with a plurality of data sources associated with the dataset and further operable to:
synchronize a local repository with at least one remote data source from the plurality of data sources; and
wherein the generation of the virtual environment uses the local repository.

21. The system of claim 20, the plurality of data sources comprising a first source associated with a first entity and a second source associated with a second entity.

22. The system of claim 13, wherein the user interacts with the dataset within the virtual environment by navigating through the dataset within the virtual environment.

23. The system of claim 13, the one or more processors further operable to generate an avatar of the user within the virtual environment.

24. The system of claim 13, wherein the dataset is complex cell interaction pathway data and wherein the user interacts with the dataset within the virtual environment presented by the display by performing one or more of the following:
navigating through views of cell interaction pathways and components;
viewing a plurality of proteins and each protein's relationships to function;
manipulating a state of a gene to visualize effects on interactions and protein states using a device coupled with the virtual immersion system; or
manipulating a protein function using the device coupled with the virtual immersion system.
